(19) United States
(12) Patent Application Publication
(10) Pub. No.: US 2003/0218988 A1
(43) Pub. Date: Nov. 27, 2003

(54) Network for transferring active packet and method for employing same

(76) Inventors: Min-Ho Han, Daejeon (KR); Jung-Chan Na, Daejeon (KR); Sung Won Sohn, Daejeon (KR)

Correspondence Address: JACOBSON HOLMAN PLLC, 400 SEVENTH STREET N.W., SUITE 600, WASHINGTON, DC, 20004, US

(21) Appl. No.: 10/235,664

(22) Filed: Sep. 6, 2002

(30) Foreign Application Priority Data
May 21, 2002 (KR) 2002-28077

(51) Int. Cl. H04L 12/28

(52) U.S. Cl. 370/254

(57) ABSTRACT

A network using an open shortest path first (OSPF) protocol includes a routing table for transferring an active packet; and a plurality of active nodes. The plurality of active nodes generates an opaque link state advertisement (LSA) having active network topology information and floods the generated opaque LSA to nodes through the OSPF domain. The active nodes also receives an opaque LSA transferred from the nodes and, then, updates the routing table for transferring the active packet based on the received opaque LSA.

### FIELD OF THE INVENTION

The present invention relates to an active network; and, more particularly, to a network for transferring an active packet to dynamically distribute active network topology information by using an extended opaque link state advertisement (LSA).

### BACKGROUND OF THE INVENTION

An OSPF (Open Shortest Path First) routing protocol serves as an interior gateway protocol (IGP) for exchanging routing information within a single autonomous system (AS). The OSPF protocol is also a link state routing protocol for exchanging only the modified link state information if a change in a link state is detected. Further, the OSPF protocol supports an opaque link state advertisement (LSA), which provides a technique capable of extending the conventional OSPF routing protocol.

Each of active nodes constituting an active network offers a means for performing a program transferred through active packets and, thus, provides a highly improved networking flexibility. Accordingly, the active network can be dynamically constituted without accompanying a downtime unlike in the case of constituting a conventional network.

However, the conventional active network technology employs a very simple routing algorithm based on a static routing table that is maintained in each router. In other words, the active nodes of the conventional active network employ a static type routing scheme where a routing table is brought from a file at a time when the active nodes initiate their operations.

However, the network using the static type routing scheme has a certain drawback in that all the operations of the nodes are required to be stopped in order to add or delete a node and, then, should be resumed after the routing table of each of the nodes is modified.

Further, it is almost impossible to convert all the routers existing on the network to active nodes for both technical and commercial reasons.

### SUMMARY OF THE INVENTION

It is, therefore, an object of the present invention to provide a network for transferring an active packet in which an active node floods an opaque LSA having active network topology information to nodes existing on an OSPF domain in order to distribute the active network topology information and constitutes a routing table for transmitting the active packet by using the flooded opaque LSA.

In accordance with one aspect of the present invention, there is provided a network using an open shortest path first (OSPF) protocol, including: an active node, which has a routing table for transferring an active packet, for generating an opaque link state advertisement (LSA) having active network topology information, flooding the generated opaque LSA to neighboring nodes through the OSPF domain, receiving an opaque LSA transferred from the neighboring nodes and, then, updating the routing table for transferring the active packet based on the received opaque LSA.

In accordance with another aspect of the present invention, there is provided a method for operating a network including an active node and general nodes, wherein the active node has a routing table for transferring an active packet, the method including the steps of: generating an opaque LSA having active network topology information by the active node and flooding the generated opaque LSA to neighboring nodes; checking whether an opaque LSA having new active node topology information has been received from the neighboring nodes; and modifying the routing table for transmitting the active packet by using the received opaque LSA if it is determined that the opaque LSA has been received and, then, flooding the received opaque LSA to a neighboring node.

In accordance with still another aspect of the present invention, there is provided a method for processing an active packet transceived between active nodes and general nodes in a network, wherein the active nodes have routing tables for transmitting the active packet, the method including the steps of: receiving the active packet and determining whether a final destination address of the received active packet is coincident with the address of the active node; searching the routing table for transmitting the active packet if it is determined that the final destination address of the received active packet is not coincident with the address of the active node and searching for a neighboring active node corresponding to the final destination address; and changing the address of the searched active packet to a destination address of the active packet and a source address of the active packet, to the address of the active node, and, then, transmitting the active packet to an active node corresponding to the destination address.

### BRIEF DESCRIPTION OF THE DRAWINGS

The above and other objects and features of the invention will become apparent from the following description of preferred embodiments given in conjunction with the accompanying drawings, in which:

FIG. 1 describes a network structure applied to the present invention;

FIG. 2 shows an opaque LSA applied to the present invention;

FIG. 3 explains a routing table for transferring an active packet stored in an active node in accordance with the present invention;

FIG. 4 schematically illustrates a structure of an active packet in accordance with the present invention;

FIG. 5 provides a flowchart describing a process for dramatically constituting a routing table in an active node by using an opaque LSA in accordance with the present invention; and

FIG. 6 sets forth a flowchart explaining a process for processing an active packet in an active node by using a routing table in accordance with the present invention.

### DETAILED DESCRIPTION OF THE PREFERRED EMBODIMENTS

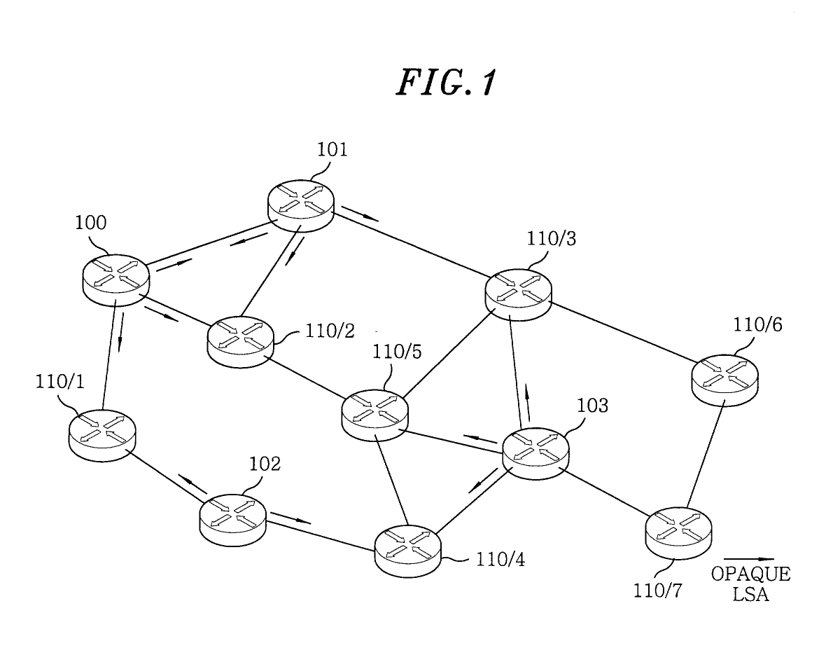

Referring to FIG. 1, there is described an active network structure in accordance with the present invention.

The network includes a plurality of active nodes 100 to 103 using an OSPF routing protocol and a multiplicity of general nodes 110/1 to 110/7. The active node 100 generates an opaque LSA having topology information of the active network by receiving an allotted opaque type for the active network. Then, the active node 100 distributes the generated opaque LSA to the other active nodes, e.g., the active nodes 101 to 103, existing on the OSPF domain.

The OSPF routing protocol used in the active nodes 100 to 103 and the general nodes 110/1 to 110/7 is an interior gateway protocol (IGP) for exchanging routing information within a single autonomous system (AS) and also a link state routing protocol for allowing only modified link state information to be exchanged when a change in a link state is detected. Further, the OSPF routing protocol supports the opaque LSA.

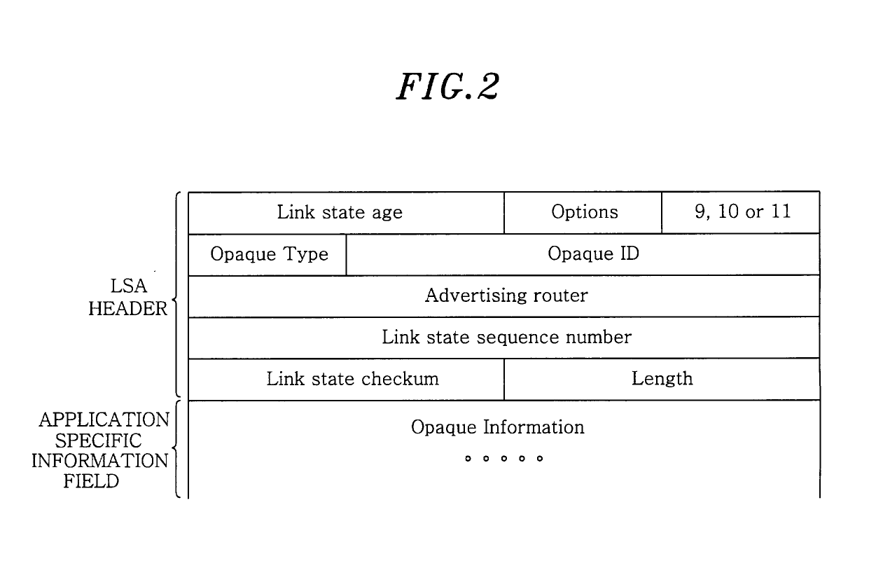

As shown in FIG. 2, the opaque LSA includes a LSA header and an application specific information field. The information field can be either directly utilized by the OSPF routing protocol or indirectly used in applications for distributing information through the OSPF domain.

The active nodes 100 to 103 distribute the opaque LSA generated or updated through the OSPF domain. At this time, the active nodes 100 to 103 employ a link-state database distribution technique for the distribution of the opaque LSA.

A link-state ID of the opaque LSA is divided into an opaque type field of 8 bits and a type-specific field of 24 bits. The active nodes 100 to 103 distribute network topology information of their own by using a link state ID field and an opaque information field. An opaque ID and the opaque information field of the opaque LSA distributed from an active node, e.g., the active node 100, store therein active network topology information.

Opaque types are managed by IANA (Internet Assigned Numbers Authority), and a new opaque type should be allocated for the extension of the OSPF routing protocol. Opaque types ranging from 0 to 127 are allotted from an IETF (Internet Engineering Task Force) while opaque types ranging from 128 to 255 remain for experimental uses. The general structure of the opaque type is defined in Table 1 below.

TABLE 1

| Value | Opaque Type |
|---|---|
| 1 | Traffic Engineering LSA |
| 2 | Sycamore Optical Topology Description |
| 3 | grace-LSA |
| 4-127 | Unassigned |
| 128-255 | Reserved for private and experimental use |

Each of the active nodes 100 to 103 stores therein the conventional routing table and, also the routing table for the transmission of the active packet. The active nodes 100 to 103 perform the routing of the active packet by using these routing tables.

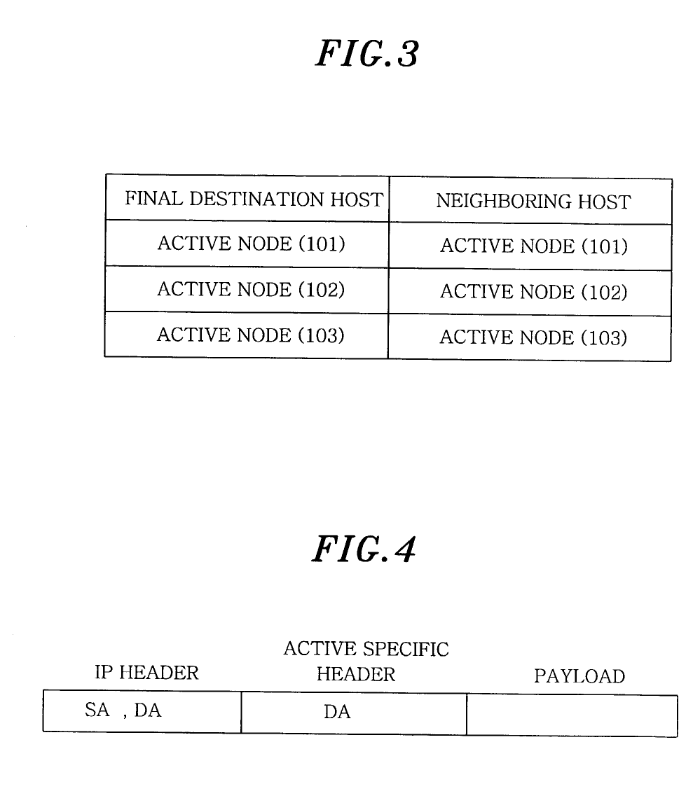

As shown in FIG. 3, the routing table for the active packet transmission, which is stored in the active node 100, has a final destination host and a neighboring host. The final destination host corresponds to a final destination address of the active packet while the neighboring host serves as a neighboring active node located on the way to the destined node.

When an opaque LSA generated by the other active node, e.g., active node 101, 102 or 103, is received, the active node 100 sets a shortest path between the active nodes by using a Dijkstra algorithm. Then, the active node 100 constitutes the routing table for the active packet transmission by using the shortest path. Thus constituted routing table is updated at a time when the active node 100 receives a new opaque LSA provided from another active node 101, 102 or 103 or when the network topology information is changed.

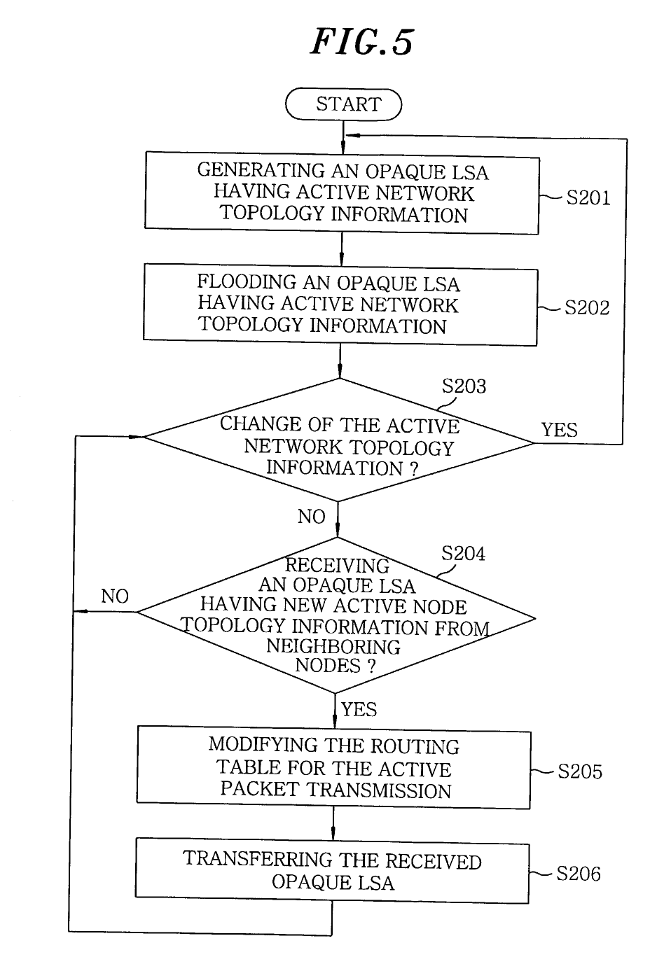

As shown in FIG. 4, an active packet transferred from each of the active nodes 101 to 103 includes an IP header, an active specific header and a payload. The IP header has a source address (SA) and a destination address (DA) and the active specific header has a final DA designating an active node to which the active packet is finally transmitted.

If the active network topology information is changed, the active node 100 performs a flooding to the other active nodes 101 to 103 that exist on the OSPF domain. Further, when an opaque LSA flooded by the active node 100 is received, the active nodes 101 to 103 update their own routing tables and, then, flood the received opaque LSA to neighboring nodes.

By the above-described operations, the routing tables for the active packet transmission can be dramatically constituted in the active nodes 100 to 103 of the active network.

A process for dramatically constituting the routing table by using the above-cited active network structure will be described with reference to FIG. 5.

FIG. 5 is a flowchart illustrating the process for dramatically constituting the routing table by using the opaque LSA in accordance with the present invention.

When initiated, an active node 100 generates an opaque LSA having active network topology information (Step 201). Then, the active node 100 floods the generated opaque LSA to neighboring nodes 101, 110/1 and 110/2 through the OSPF domain (Step 202).

The active node 100 checks at a predetermined time interval whether the active network topology information has been changed or not (Step 203). When it is determined in the step 202 that the active network topology information has not been changed, the active node 100 then determines whether an opaque LSA having new active node topology information is provided from the neighboring nodes 101, 110/1 and 110/2 (Step 204).

When it is found in the step 204 that the opaque LSA having the new active node topology information has been provided from another active node, e.g., the active node 101, the active node 100 modifies the routing table for the active packet transmission by using the active network topology information stored in the received opaque LSA (Step 205).

Thereafter, the active node 100 transfers the opaque LSA transferred from the neighboring nodes 110/1 and 110/2 (Step 206).

If it is determined in the step 203, on the other hand, that the active network topology information has been changed, the active node 100 returns to the step 201 to generate an opaque LSA having new active node topology information and then floods the generated opaque LSA to the neighboring active node 101 and the nodes 110/1 and 110/2. Then, the active node 100 returns again to the step 204 and resumes to check whether the opaque LAS having the new active node topology information is received from the neighboring nodes 101, 110/1 and 110/2.

If it is determined in the step 204 that the opaque LSA has not been received from the neighboring nodes 101, 110/1 and 110/2, the active node 100 returns back to the step 203 and performs the remaining steps.

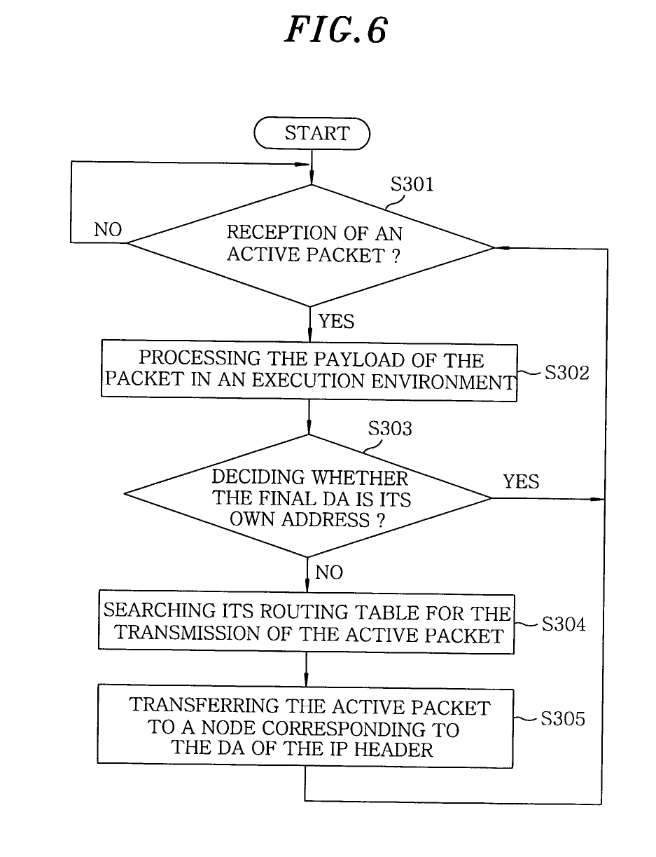

Referring to FIG. 6, there is illustrated a process for transferring the active packet between the active nodes of the active network.

FIG. 6 offers a flowchart explaining a process for processing the active packet by using the routing table in accordance with the present invention.

An active node 100 determines whether the active packet has been received or not (Step 301).

If it is determined in the step 301 that the active packet has not been received, the active node 100 returns to the step 301 and continues to check the arrival of the active packet.

If it is found, however, in the step 301 that the active packet has been received, the active node 100 processes the payload of the packet in an execution environment (Step 302). Subsequently, the active node 100 searches for the final DA recorded in the active characteristic header of the packet and decides whether the searched final DA is coincident with its own address (Step 303).

If the final DA of the active packet is found in the step 303 to be coincident with its own address, the active node 100 returns to the step 301 to check whether an active packet is received.

On the other hand, if the final DA of the active packet is determined in the step 303 to be different from the address of the active node 100, the active node 100 searches for its routing table for the transmission of the active packet (Step 304). Then, the active node 100 generates a SA and a DA of the IP header of the active packet by referring to the searched routing table and, then, transfers the active packet to a node corresponding to the DA of the IP header (Step 305).

By repeatedly performing the above-described series of processes, the active packet can be transferred to the active node corresponding to the final DA.

The following are descriptions of the process for transferring the active packet by using the routing table for the transmission of the active packet. Herein, it is assumed that the active node 100 transmits the active packet to the active node 103 for illustration.

By referring to its own routing table for transmitting active packet, the active node 100 confirms that the active node 101 is a neighboring host of the active node 103, which is defined as a final destination host. Then, the active node 100 generates an active packet having an IP header, an active characteristic header and a payload, in which the SA and the DA of the IP header are set to be the active node 100 and the active node 101, respectively, and the DA of the active characteristic header is set to be the active node 103. Thereafter, the active node 100 transfers the generated active packet to the active node 101.

When the active packet is provided from the active node 100, the active node 101 processes the content of the payload of the received active packet in the execution environment and confirms that the final DA is the active node 103 by referring to its own routing table for the transmission of the active packet. Then, the active node 100 converts the SA and the DA of the IP header into the active node 101 and the active node 103, respectively, and, then, provides the modified active packet to the active node 103.

The payload of the active packet transferred to the active node 103 is processed in the execution environment. Since the DA of the active packet is the active node 103, the process for transmitting the active packet to the final destination is finally completed.

As described above, an active node can flood an opaque LSA having active node topology information through the extension of an OPFG routing protocol and dramatically constitute a routing table for the transmission of an active packet without modifying the structure of existing general nodes by using a flooded opaque LSA.

While the invention has been shown and described with respect to the preferred embodiments, it will be understood by those skilled in the art that various changes and modifications may be made without departing from the spirit and scope of the invention as defined in the following claims.

What is claimed is:

1. A network using an open shortest path first (OSPF) protocol, comprising:
an active node, which has a routing table for transferring an active packet, for generating an opaque link state advertisement (LSA) having active network topology information, flooding the generated opaque LSA to neighboring nodes through the OSPF domain, receiving an opaque LSA transferred from the neighboring nodes and, then, updating the routing table for transferring the active packet based on the received opaque LSA.

2. The network of claim 1, wherein the routing table includes final destination address information and address information of the neighborhood nodes.

3. The network of claim 1, wherein the active packet includes an IP header, an active specific header and a payload, wherein the IP header has a source address and a destination address and the active specific header has a final destination address of the active packet.

4. The network of claim 1, wherein the opaque LSA includes an opaque ID having network topology information and an opaque information field.

5. A method for operating a network including an active node and general nodes, wherein the active node has a routing table for transferring an active packet, the method comprising the steps of:
generating an opaque LSA having active network topology information by the active node and flooding the generated opaque LSA to neighboring nodes;
checking whether an opaque LSA having new active node topology information has been received from the neighboring nodes; and
modifying the routing table for transmitting the active packet by using the received opaque LSA if it is determined that the opaque LSA has been received and, then, flooding the received opaque LSA to a neighboring node.

6. The method of claim 5, wherein the active node generates an opaque LSA having an active node topology if the network topology information of the active node is changed and, then, flooding the generated opaque LSA to the neighboring nodes.

7. A method for processing an active packet transceived between active nodes and general nodes in a network, wherein the active nodes have routing tables for transmitting the active packet, the method comprising the steps of:
receiving the active packet and determining whether a final destination address of the received active packet is coincident with an address of an active node among the active nodes;
searching the routing table for transmitting the active packet if it is determined that the final destination address of the received active packet is not coincident with the address of the active node, to thereby detect a neighboring active node corresponding to the final destination address; and
changing the address of the detected active node to a destination address of the active packet and a source address of the active packet, to the address of the active node, and, then, transmitting the active packet to an active node corresponding to the destination address.
